(19) United States
(12) Patent Application Publication
(10) Pub. No.: US 2007/0175683 A1
(43) Pub. Date: Aug. 2, 2007

(54) Air intake sound transmission device and method

(76) Inventors: Tatsuya Miyake, Isehara-shi (JP); Akane Urata, Fujisawa-shi (JP)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/699,870

(22) Filed: Jan. 30, 2007

(30) Foreign Application Priority Data
Jan. 31, 2006 (JP) 2006-023517
Dec. 11, 2006 (JP) 2006-333379

(51) Int. Cl. B62D 25/10; F02M 35/02

(52) U.S. Cl. 180/69.22; 123/198 E

(57) ABSTRACT

An air intake sound transmission device of a vehicle is disclosed. The air intake sound transmission device comprises an engine hood and an intake channel. The engine hood has a vibratory portion. The intake channel connects an inlet of an engine to a fresh-air inlet. The intake channel further includes an opening positioned at an intermediate section thereof. The opening faces the engine hood and transmits pressure fluctuations in the intake channel caused by operation of the engine to the vibratory portion of the engine hood. The vibratory portion of the engine hood vibrates in response to the pressure fluctuations. A method of generating an air intake sound is also disclosed.

### CROSS-REFERENCE TO RELATED APPLICATIONS

This application claims priority from Japanese Patent Applications Serial No. 2006-023517 filed Jan. 31, 2006, and Serial No. 2006-333379 filed Dec. 11, 2006, the disclosures of which, including their specifications, drawings and claims, are incorporated herein by reference in their entirety.

### BACKGROUND

1. Technical Field

The present disclosure relates to an air intake sound transmission device and method for transmitting an air intake sound to an interior of a vehicle.

2. Description of the Related Art

Conventionally, efforts have been made to reduce air intake sound since it is considered to be undesirable external noise to vehicle occupants. However, in recent years, there have been attempts made to produce a specific sound inside a vehicle by intentionally allowing vehicle occupants to hear the air intake sound.

Japanese Unexamined Patent Application Publication No. 2004-218458 discloses an example of a technique for transmitting an air intake sound of an engine to the interior of a vehicle. In this technique, an engine room is separated into first and second engine rooms. The second engine room is located proximate to a dash panel and the first engine room is located adjacent to the second engine room. An inlet of the engine that is disposed inside the first engine room is connected to a fresh-air inlet by an intake pipe. The intake pipe has an opening in a sidewall thereof, which is located proximate to the fresh-air inlet. The opening and an upper plate of a dash panel located proximate to the driver's seat are connected to each other with a flexible tube that extends from the first engine room into the second engine room through the inside of a fender. Pressure fluctuation of an air intake sound in the intake channel is transmitted to the dash panel via the flexible tube, causing the dash panel to vibrate and producing sound. As a result, air intake sound is transmitted to the interior of the vehicle.

### SUMMARY

While the above-described conventional technique produces sound, the range for sound amplification is small. Accordingly, there are instances where the sound does not reach a desired sound level for the vehicle occupants.

An air intake sound transmission device of a vehicle is disclosed. The air intake sound transmission device comprises an intake channel and an engine hood. The engine hood has a vibratory portion. The intake channel connects an inlet of an engine to a fresh-air inlet. The intake channel further includes an opening positioned at an intermediate section thereof. The opening faces the engine hood and transmits pressure fluctuations in the intake channel caused by operation of the engine to the vibratory portion of the engine hood.

### BRIEF DESCRIPTION OF THE DRAWINGS

Other features and advantages of the present invention will be apparent from the ensuing description, taken in conjunction with the accompanying drawings, in which:

FIG. 1 is a plan view showing a configuration of an air intake sound transmission device according to a first embodiment;

FIG. 2 is a cross-sectional view taken along line II-II in FIG. 1.

FIG. 3 is a graph that illustrates a relationship between a sound pressure level and a first order component of revolution for every combustion;

FIG. 4 is a plan view showing a configuration of an air intake sound transmission device according to a second embodiment; and

FIG. 5 is a cross-sectional view taken along line V-V in FIG. 4.

### DESCRIPTION OF THE PREFERRED EMBODIMENTS

While the claims are not limited to the illustrated embodiments, an appreciation of various aspects of the system is best gained through a discussion of various examples thereof. Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description. Exemplary embodiments of the present invention are described in detail by referring to the drawings as follows.

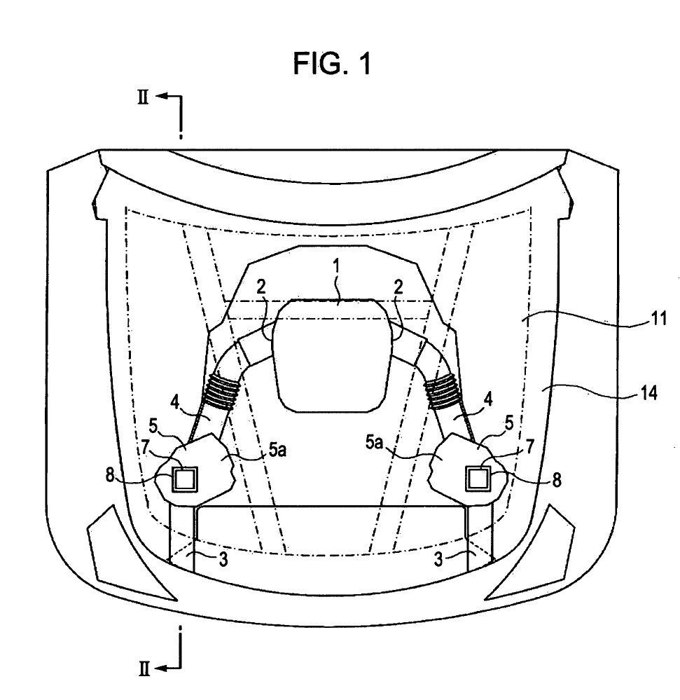

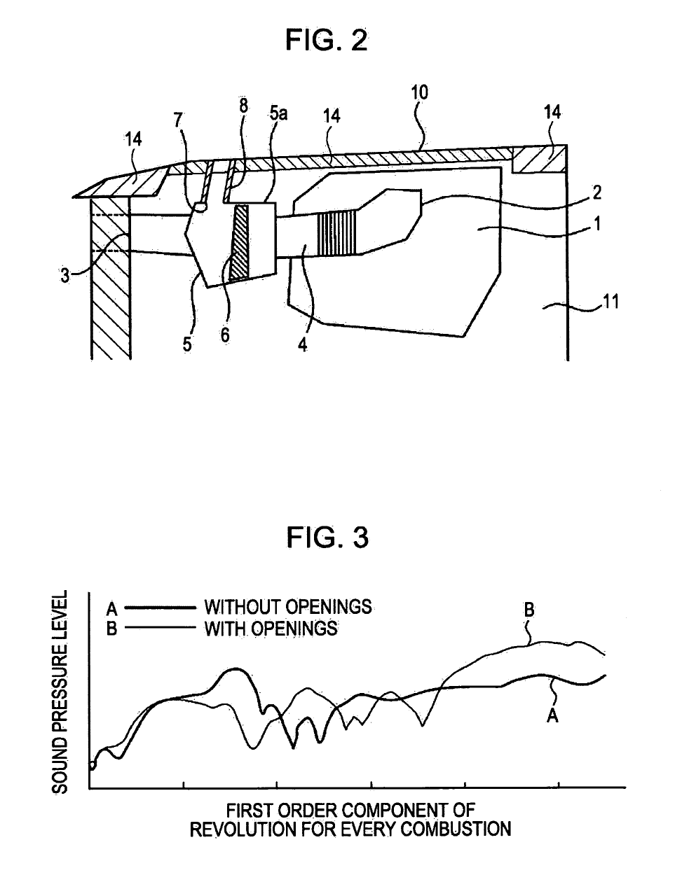

Referring to FIGS. 1 and 2, the configuration of a first embodiment of an air intake sound transmission device for a vehicle will be described in detail. In the first embodiment, an engine 1 is disposed inside an engine room 11. The engine 1 has left and right inlets 2 that are respectively connected to left and right fresh-air inlets 3 by left and right intake pipes 4. In one embodiment, the fresh-air inlets 3 are located at the front side of the vehicle. An intermediate section of each intake pipe 4 is provided with an air-cleaner box 5. The air-cleaner box 5 serves as an extended portion having a hollow section that is larger than that of the intake pipe 4 (see, e.g., FIG. 2). Each air-cleaner box 5 contains a filter 6 for preventing foreign material from entering the engine 1. The intake pipes 4 and the air-cleaner boxes 5 comprise intake channels.

As shown in FIGS. 1 and 2, each air-cleaner box 5 has an upper plate 5a that faces an engine hood 10 disposed thereabove. The upper plate 5a further has an opening 7 for transmitting vibration from the intake channel. The opening 7 is disposed in the upper plate 5a in a manner such that the opening 7 is positioned between the fresh-air inlet 3 and the filter 6.

Furthermore, the periphery of each opening 7 is surrounded by a tubular elastic member 8. The tubular elastic member 8 has an axis extending therethrough that extends in the vertical direction and has an upper hollow end and a lower hollow end. The lower hollow end is fixed to the air-cleaner box 5 around the opening 7. The upper hollow end of the tubular elastic member 8 extends towards the engine hood 10 disposed thereabove. The length of the elastic member 8 is set such that the upper hollow end of the elastic member 8 is in contact with the engine hood 10 when the engine hood 10 is closed. The inner surface of the engine hood 10, that is, the surface proximate to the engine room 11, is provided with a reinforcement member 14 for reinforcing the engine hood 10, thereby increasing the rigidity of the engine hood 10. From a top view of the vehicle, the vibration-transmission openings 7 and the upper hollow ends of the elastic members 8 are located at positions where they do not to overlap with the position of the reinforcement member 14. In other words, the vibration-transmission openings 7 and the upper hollow ends of the elastic members 8 are provided where the rigidity of the engine hood 10 is relatively low.

To improve contact between the elastic members 8 and the engine hood 10, the length of each of the elastic members 8 is preferably set such that when the upper hollow end of the elastic member 8 is in contact with the closed engine hood 10, the elastic member 8 is slightly compressed in the vertical direction due to a downward pressing force of the engine hood 10.

The lower hollow end of each tubular elastic member 8 may be fixed to the top surface of the upper plate 5a of the corresponding air-cleaner box 5 by a mounting bracket or by bonding. As a further alternative, the lower hollow end of each tubular elastic member 8 may be partially or entirely press-fit in the corresponding opening 7.

Furthermore, while FIG. 1 depicts the cross-sectional shape of the openings 7 and the tubular elastic members 8 as being square-shaped, it is understood that the openings 7 and tubular elastic members 8 do not necessarily need to be square-shaped, nor do they need to be circular. Further, it is also not necessary that the openings 7 and corresponding tubular elastic members 8 have corresponding shapes. Moreover, the hollow section of the elastic members 8 does not have to be constant in the vertical direction. For example, the elastic members 8 may be conical such that the hollow section thereof increases towards the engine hood 10. Furthermore, the vertical axis of the elastic members 8 does not necessarily have to extend in the vertical direction. For example, the axis may have a lower axis portion that extends vertically and an upper axis portion that is slanted towards a dash panel in one of the front, rear, left, and right directions.

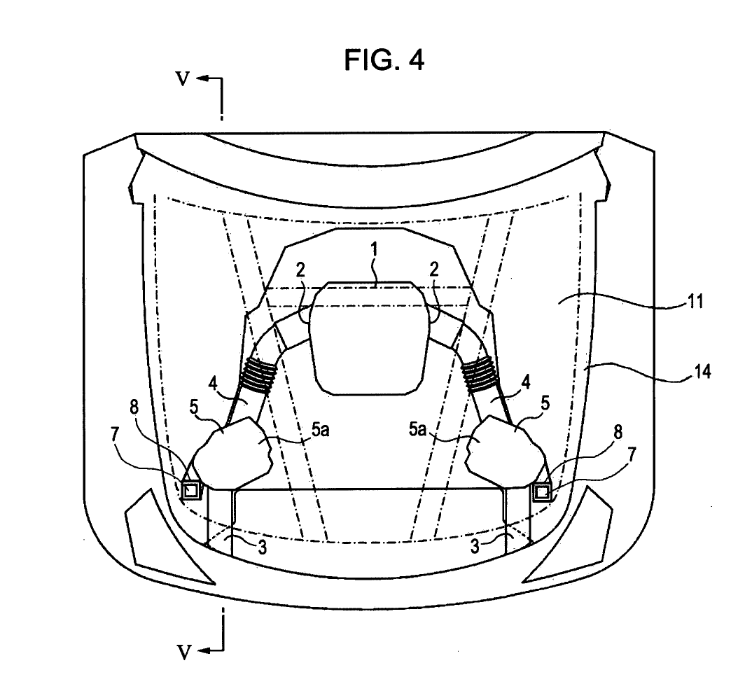

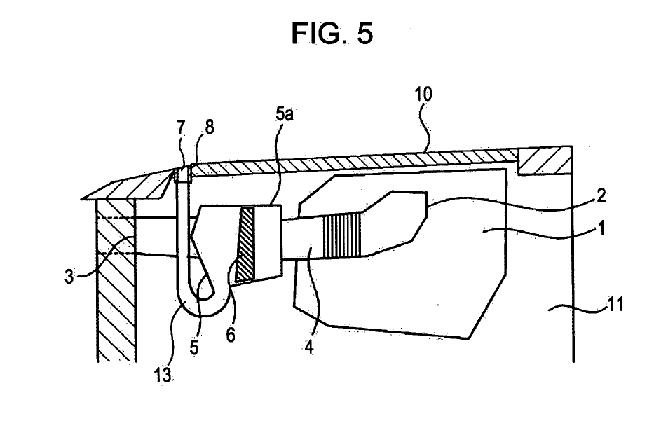

Furthermore, the openings 7 that face the engine hood 10 do not necessarily have to be provided directly in the intake pipes 4. For example, referring to FIGS. 4 and 5, each of the intake channels may additionally include a branch pipe (branch channel) 13. Each of the branch pipes 13 is connected to the corresponding intake pipe 4 (namely, the corresponding air-cleaner box 5 in this embodiment) and has one of the openings 7 facing the engine hood 10 at the tip end of the branch pipe 13. Thus, each opening 7 is disposed facing the engine hood 10 by means of the corresponding branch pipe 13. Referring to FIG. 4, from a top view of the vehicle, the upper hollow ends of the elastic members 8 and the openings 7 at the tip end of the branch pipes 13 are located at positions where they do not overlap with the position of the reinforcement member 14. In other words, the upper hollow ends of the elastic members 8 and the openings 7 are provided where the rigidity of the engine hood 10 is relatively low.

In the embodiment depicted in FIG. 5, the sections of the intake pipes 4 to which the branch pipes 13 are connected do not necessarily have to face the engine hood 10. The use of the branch pipes 13 in this manner allows for transmission of pressure fluctuation to the engine hood 10 even when it is difficult to provide the openings 7 facing the engine hood 10 directly in the intake pipes 4.

Generation of the air intake sound will now be described in connection with the above described embodiment. In the configuration described above, when the engine 1 is in operation, air is introduced into the engine 1 through the intake pipes 4. Since the air flows intermittently into the cylinders, the air taken into the intake pipes 4 generates a pulse, thus creating air resonance in the intake pipes 4. The air resonance increases, particularly during an acceleration period in which the amount of air taken into the engine 1 increases.

Pressure fluctuation in the intake pipes 4 produced as a result of the air resonance is transmitted to the lower surface of the engine hood 10 which is positioned above the openings 7. In response to the pressure fluctuation, the engine hood 10 vibrates vertically. Because the engine hood 10 has a large surface area, when the engine hood 10 vibrates, the engine hood 10 gives pressure fluctuation to the air with its large surface area, thereby creating a loud sound. According to this arrangement, the air intake sound is then amplified within the engine room 11 and is transmitted to the interior of the vehicle so as to be heard by a vehicle occupant. In the first embodiment, because the engine hood 10 is generally positioned close to the intake pipes 4, a long flexible tube is not necessary, thus the present embodiment achieves an efficient use of space.

Furthermore, as may be seen when viewing the vehicle from a top view (FIG. 1, FIG. 4), the vibration-transmission openings 7, the upper hollow ends of the elastic members 8, and the openings 7 at the tip end of the branch pipes 13 are located at positions where they do not to overlap with the position of the reinforcement member 14 and where the rigidity of the engine hood 10 is relatively low. Consequently, the engine hood 10 can vibrate by a greater degree, thereby improving the amplification efficiency of the air intake sound.

FIG. 3 illustrates a comparison of sound pressure levels between an embodiment of an air intake transmission provided with the openings 7 such as those provided in the embodiments described above (designated as B), and an example without the openings 7 (designated as A). As may be seen the sound pressure levels for the embodiment B is much higher than the embodiment A without the openings.

In the embodiments described herein, the vibration-transmission openings 7 are disposed facing the engine hood 10 so that the pressure fluctuation within the intake pipes 4 can be applied directly to the engine hood 10. The openings 7 are preferably disposed close to the engine hood 10 such that the distance between the openings 7 and the engine hood 10 is kept as short as possible. This allows the engine hood 10 to vibrate more readily.

The pressure fluctuation from each opening 7 passes through the hollow portion of a corresponding elastic member 8. This passage permits the pressure fluctuation to be transmitted to the engine hood 10 efficiently and without being diffused towards the periphery of the opening 7.

Even though the openings 7 are provided in the intake pipes 4, the elastic members 8 disposed between the periphery of the openings 7 and the engine hood 10 prevent hot air of the engine 1 from being taken into the intake pipes 4 through the openings 7. Thus, the temperature of the intake air is prevented from increasing. An increase in temperature of the intake air can unfavorably lead to lower output from the engine 1.

Water from the outside of the vehicle may enter the engine room 11. However, the elastic members 8 may advantageously prevent the water from entering the intake pipes 4 through the openings 7. This is advantageous in view of the fact that water entering the intake pipes 4 can lead to an adverse effect on the engine 1. Furthermore, the elastic members 8 may also prevent foreign material from entering the intake pipes 4 through the openings 7.

Even if foreign material enters the intake pipes 4 through the openings 7, since the openings 7 are disposed between the fresh-air inlets 3 and the filters 6, the filters 6 may catch the foreign material so as to prevent it from being taken into the inlets 2 of the engine 1, thereby preventing engine failure.

As mentioned above, the air-cleaner boxes 5 serve as extended portions having a greater cross section than the intake pipes 4. Therefore, each air-cleaner box 5 functions as an extended chamber where the pressure fluctuation in the corresponding intake pipe 4 may be amplified. Consequently, by providing the openings 7 in the extended portions, the engine hood 10 may be vibrated with the amplified pressure fluctuation, whereby the amplification efficiency is increased. In particular, since the openings 7 are provided in the air-cleaner boxes 5, there is no need for providing additional extended portions as separate components.

Although the openings 7 are provided in the air-cleaner boxes 5 in the above-described embodiment, the openings 7 may alternatively be provided in the intake pipes 4. Moreover, the number of openings 7 may be two or more. Furthermore, each of the openings 7 may alternatively be disposed between the corresponding filter 6 and the corresponding inlet 2 of the engine 1 as the elastic members 8 may also prevent foreign material and water from entering the openings 7.

The preceding description has been presented only to illustrate and describe exemplary embodiments of the claimed invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. An air intake sound transmission device of a vehicle comprising:
an engine hood having a vibratory portion; and
an intake channel that connects an inlet of an engine to a fresh-air inlet, wherein the intake channel further includes an opening positioned at an intermediate section thereof, wherein the opening faces the engine hood, and wherein pressure fluctuations in the intake channel caused by operation of the engine is transmitted to the vibratory portion of the engine hood through the opening so as to vibrate the vibratory portion.

2. The air intake sound transmission device according to claim 1, wherein the intake channel comprises an intake pipe and an extended portion, wherein the extended portion is in communication with the opening.

3. The air intake sound transmission device according to claim 2, wherein the extended portion comprises an air-cleaner box containing a filter.

4. The air intake sound transmission device according to claim 1, wherein the intake channel includes a filter disposed in the intermediate section thereof, and wherein the opening is disposed between the fresh-air inlet and the filter.

5. The air intake sound transmission device according to claim 1, wherein the intake channel includes a branch channel and wherein the branch channel has the opening positioned at a tip end of the branch channel.

6. The air intake sound transmission device according to claim 5, wherein the intake channel further comprises an extended portion positioned at the intermediate section and wherein the extended portion is connected to a base end of the branch channel.

7. The air intake sound transmission device according to claim 6, wherein the extended portion comprises an air-cleaner box containing a filter.

8. The air intake sound transmission device according to claim 1, further comprising an elastic member that is disposed so as to surround a periphery of the opening, wherein the elastic member extends towards the engine hood and includes an end that is in contact with the engine hood.

9. The air intake sound transmission device according to claim 1, wherein the engine hood further comprises a low rigidity portion.

10. The air intake sound transmission device according to claim 9, wherein the low rigidity portion of the engine hood extends around a periphery of the vibratory portion.

11. A method of transmitting an air intake sound, comprising:
introducing air into an engine through an intake channel;
and
transmitting a pressure fluctuation in the intake channel to a vibratory portion of an engine hood so as to vibrate the vibratory portion to amplify sound.

12. An air intake sound transmission device for a vehicle comprising:
an intake channel that connects an inlet of an engine to a fresh-air inlet, and
a pipe that communicates with the intake channel;
wherein the pipe includes an opening that faces a vibratory portion of an engine hood.

13. An air intake sound transmission device for a vehicle comprising:
an elastic member that is disposed so as to surround a periphery of the opening of an intake channel that connects an inlet of an engine to a fresh-air inlet, wherein the elastic member extends towards a vibratory portion of an engine hood and has an end that contacts the vibratory portion.

14. An air intake sound transmission device of a vehicle, comprising:
an engine hood having a vibratory means; and
an intake means that connected to an inlet of an engine to a fresh-air means, wherein the intake means further includes an opening positioned at an intermediate section thereof, wherein the opening faces the engine hood, and wherein pressure fluctuations in the intake means caused by operation of the engine is transmitted to the vibratory means of the engine hood through the opening so as to vibrate the vibratory means.
